(19) United States
(12) Patent Application Publication
(10) Pub. No.: US 2026/0182733 A1
(43) Pub. Date: Jul. 2, 2026

(54) STRUCTURE OF FOLDABLE TABLE

(71) Applicant: YI-CHUN CHEN, Taipei City (TW)

(72) Inventor: YI-CHUN CHEN, Taipei City (TW)

(21) Appl. No.: 19/002,555

(22) Filed: Dec. 26, 2024

(51) Int. Cl. A47B 3/08; B60B 33/06

(52) U.S. Cl. CPC A47B 3/08; B60B 33/063

(57) ABSTRACT

A foldable table includes a table top having an undersurface of which two opposite side portions are respectively connected to rotatable frames, which are rotatably mounted to top ends of table legs. Adjustable support rods are provided on a bottom of each table leg. A lifting caster frame is arranged in an interior of each table leg. Casters are mounted to a bottom of each lifting caster frame. The lifting caster frames are respectively connected to the rotatable frames, so that the table top and the rotatable frames are rotatable from a horizontal direction (a state of use) to a vertical direction (a movable state), and the lifting caster frames are caused to move downward to have the casters protruding out of the table legs to contact a ground surface for easy movement of the table.

### BACKGROUND OF THE INVENTION

### (a) Technical Field of the Invention

The present invention relates generally to a foldable table, and more particularly to a structure of foldable table that allows casters to be received in interiors of table legs.

### (b) Description of the Prior Art

When flexible space planning is required, foldable tables are often used instead of fixed tables, so that the tables can be folded and stored when not in use to reduce the space occupied. Such foldable tables must also be easily moveable to a designated position and are often provided with multiple casters under the table legs to be placed on the ground. However, in order to facilitate movement, the casters are usually allowed to rotate 360 degrees horizontally. Therefore, after moving to the designated position, even if the casters are locked and cannot roll, the casters are still slightly rotatable, causing the table to move unexpectedly.

Further, the known casters do not have a height adjustment mechanism. If the ground is uneven, the casters cannot be all set to be in contact with the ground, causing the table to shake.

### SUMMARY OF THE INVENTION

The primary objective of the present invention is to provide a structure of foldable table, wherein when a table top is set in a horizontal use state, casters are retracted and adjustable support rods are set contact a ground surface in order to handle unevenness of the ground surface; and when the table top is set in a rotated ready-to-move state, the rotation of the table top causes the casters to be pushed downwards to a position of protruding out of the table legs, so that the casters are set in contact with the ground surface for easy movement.

To achieve the above objective, the present invention provides a structure of foldable table, which comprises a table top, two table legs, a cross bar connected between the table legs, and two rotatable frames. Two opposite side portions of an undersurface of the table top are each connected to a rotatable frame, and the rotatable frames are respectively mounted to top ends of the table legs. Each of the table legs is provided, on a bottom thereof, with a plurality of adjustable support rods. Each of the table legs is provided with a lifting caster frame arranged in an interior thereof, and each of the lifting caster frames is provided, on a bottom thereof, with a plurality of casters. The lifting caster frames are respectively connected to the rotatable frames, so that when the table top is rotated together with the rotatable frames from a horizontal direction to a vertical direction, the lifting caster frames are caused to move downwards to have the casters protruding out of the table legs.

In one embodiment, the table legs are each formed, in an interior thereof, with a table leg receiving space to receive a respective one of the lifting caster frames therein. A rotation axle is mounted on a top end of each of the table legs to protrude inwards. The rotatable frames are respectively sleeved around outside peripheries of the rotation axles, so that the rotatable frames are located inwardly of the respective one of the table legs. The cross bar is connected between the rotation axles, and the cross bar fixes the table legs not to rotate. The top end of each of the table legs is provided, at one side of the respective one of the rotation axles, with a rotation hole, meaning the rotation axle is slightly smaller than the top end of the table leg so that a space is left at one side to form the rotation hole. Each of the rotatable frames includes a driving peg projecting toward the respective one of the rotation holes, and the driving pegs respectively extend through the rotation holes to reach into the table leg receiving spaces. The driving pegs are respectively connected to the lifting caster frames. Each of the rotatable frames is formed, in an interior thereof, with a lock accommodation space in which a locking bar is received. Each of the rotation axles is provided, in a manner of being arranged circumferentially therearound, with a plurality of locking notches, and the locking bar is arranged to be extendable and retractable to selectively fit into and engage with one of the locking notches.

The rotation holes are each structured to extend along a circumference of the respective one of the rotation axles. When the rotatable frames are rotated, the driving pegs are caused to perform a circular motion, so that the circumferential extension of the rotation holes allows the driving pegs to move with the rotation of the rotatable frames without being interfered with. Each of the lifting caster frames is provided, on a top thereof, with a connection member that receives the respective one of the driving pegs to fit therein and connect therewith, so that when the rotatable frames are rotated, the movements of the driving pegs drive the lifting caster frames to move. The connection members are each formed with an elongated circular hole extending in a horizontal direction to fit over and connect to the respective one of the driving pegs, in order to allow the circular motions of the driving pegs to be smoothly converted into vertical movements of the lifting caster frames.

In one embodiment, a driving bar is connected between the locking bars, so that a user may operate the driving bar to simultaneously move the locking bars out of the locking notches, in order to enable rotation of the table top and the rotatable frames. Each of the locking bars is connected to a return spring in order to have the locking bar pre-set in engagement with a predetermined one of the locking notches. When the locking bar is released by a user and rotated to a designated position, the locking bar is biased and pushed by the return spring to get into another one of the locking notches. The driving peg and the locking bar are respectively located at two opposite sides of the rotation axle, for example, the driving peg being arranged at a lower side when the table top is in a rotated state, and the locking bar being arranged at an upper side when the table top is in the rotated state. The adjustable support rods are mounted through screwing to the bottoms of the table legs, so that a user is allowed to adjust the height of each of the adjustable support rods through rotation.

The advantage of the present invention is that when the table top is set horizontal and in a state of use, the casters are retracted, so that positional change caused by rotation (not rolling) of the casters may not happen, and the adjustable support rods can be adjusted for the height thereof contacting the ground surface in order to handle unevenness of the ground surface, so that even the ground surface is irregular or uneven, the present invention does not shake; and when the present invention is to be moved, through rotation of the table top, the casters are pushed downward to a position of protruding out of the table legs, so that the casters are set in contact with the ground surface for easy movement, featuring both stability of use and easiness of stowage.

### BRIEF DESCRIPTION OF THE DRAWINGS

FIG. 1 is a perspective illustrating a state of use of the present invention.

FIG. 2 is a front view of FIG. 1.

FIG. 3 is a perspective view illustrating a state of moving of the present invention.

FIG. 4 is a front view of FIG. 3.

FIG. 5 is a first schematic view illustrating movement of a lifting caster frame of the present invention.

FIG. 6 is a second schematic view illustrating the movement of the lifting caster frame of the present invention.

FIG. 7 is a first schematic view illustrating movement of a rotatable frame of the present invention.

FIG. 8 is a second schematic view illustrating the movement of the rotatable frame of the present invention.

### DETAILED DESCRIPTION OF THE PREFERRED EMBODIMENTS

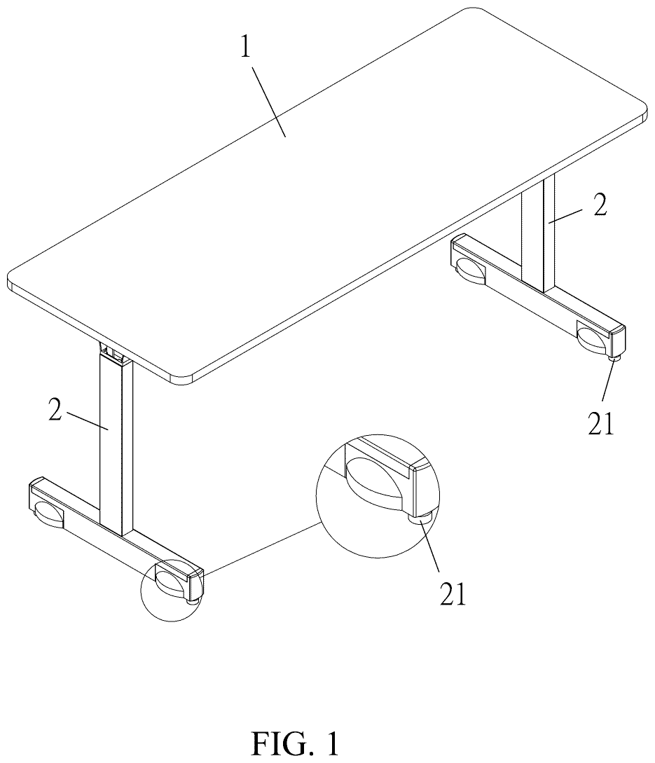

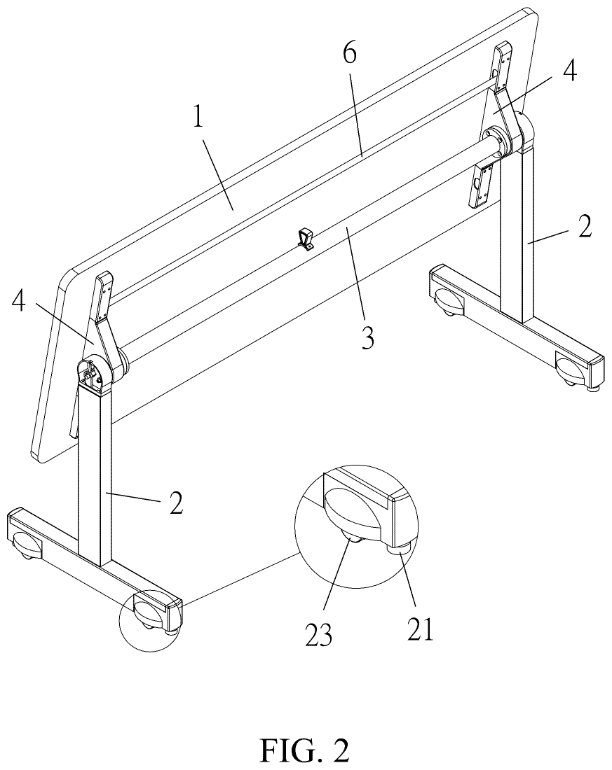

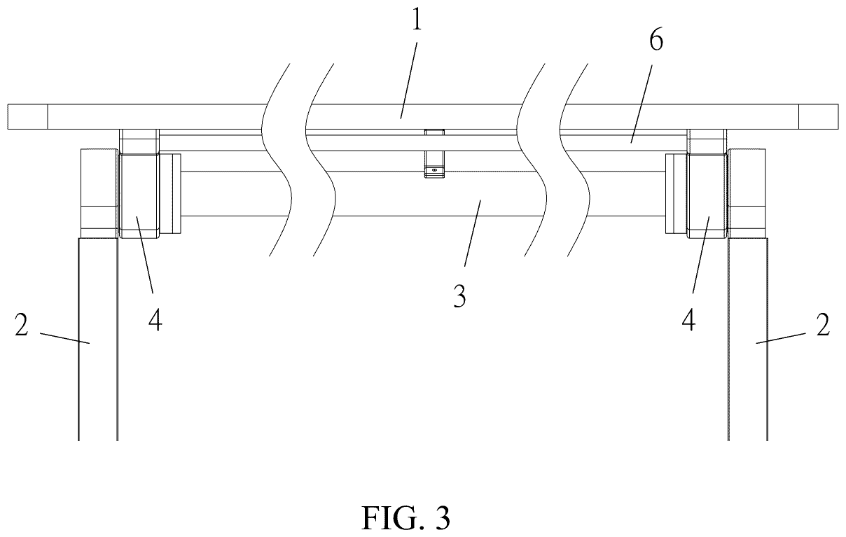

Referring to FIGS. 1-4, drawings illustrating one way of implementing the present invention are provided. The drawings show that a structure of foldable table according to the present invention comprises a table top 1, two table legs 2, a cross bar 3 connected between the table legs 2, and two rotatable frames 4. Two opposite side portions of an undersurface of the table top 1 are each connected with a rotatable frame 4, and the rotatable frames 4 are respectively land rotatably mounted to top ends of the table legs 2. Each of the table legs 2 is provided, on a bottom thereof, with a plurality of adjustable support rods 21. The feature of the structure of foldable table is that each of the table legs 2 is provided with a lifting caster frame 22 arranged in an interior thereof. Each of the lifting caster frames 22 is provided, on a bottom thereof, with a plurality of casters 23. The lifting caster frames 22 are respectively connected to the rotatable frames 4, so that when the table top 1 and the rotatable frames 4 are rotated from a horizontal direction to a vertical direction, the lifting caster frames 22 are caused to move downwards to have the casters 23 protruding out of the table legs 2. In the instant embodiment, the adjustable support rods 21 are respectively mounted, by means of screw fastening, to the bottoms of the table legs 2, so that a user is allowed to adjust a height of each of the adjustable support rods 21 by rotating and thus screwing the adjustable support rod 21, wherein screwing the adjustable support rods 21 into the table legs 2 reduces the height and screwing the adjustable support rods 21 out of the table legs 2 increases the height.

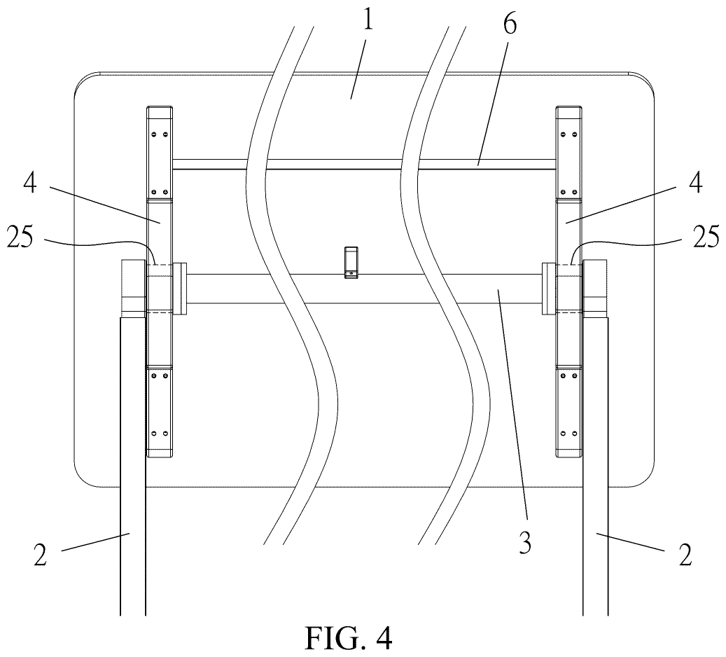

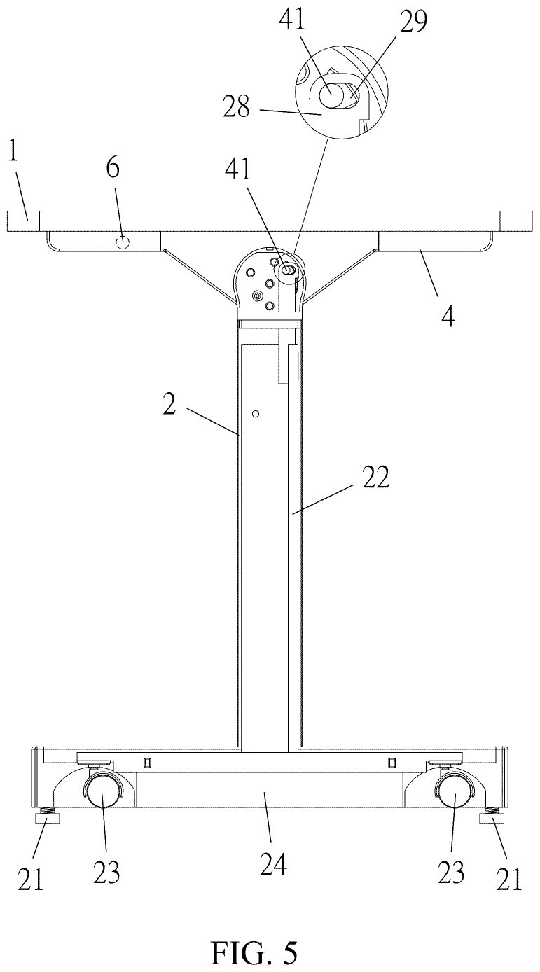

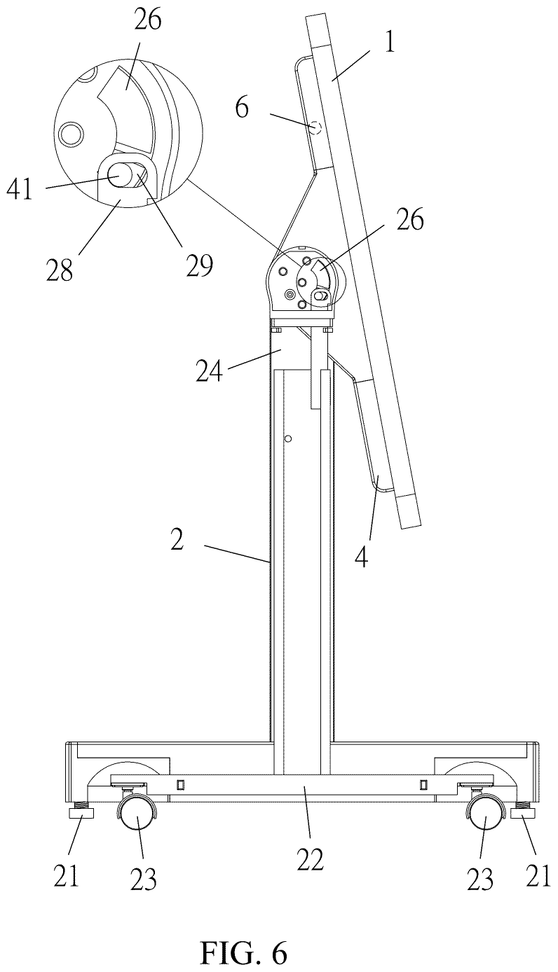

FIGS. 4-8 show that in the instant embodiment, the table legs 2 are each formed, in the interior thereof, with a table leg receiving space 24 to receive the respective one of the lifting caster frames 22 to arrange therein. The lifting caster frames 22 are generally of an inverted T-shape. A rotation axle 25 is mounted on the top end of each of the table legs 2 and protrude inwards. The rotatable frames 4 are respectively arranged around outside peripheries of the rotation axles 25, so that the rotatable frames 4 are each located inwardly of the respective one of the table legs 2. The cross bar 3 is connected between the rotation axles 25, and the cross bar 3 fixes the table legs 2 not to rotate. The top end of each of the table legs 2 is provided, at one side of the respective one of the rotation axles 25, with a rotation hole 26, meaning for each of the rotation axles 25, there is a space reserved for the rotation hole 26 at one side thereof. Each of the rotatable frames 4 includes a driving peg 41 that projects toward the respective one of the rotation holes 26, and the driving pegs 41 respectively extend through the rotation holes 26 to reach into the table leg receiving spaces 24. The driving pegs 41 are respectively connected to the lifting caster frames 22. Each of the rotatable frames 4 is formed, in an interior thereof, with a lock accommodation space 42 in which a locking bar 5 is received. Each of the rotation axles 25 is provided with a plurality of locking notches 27 that are circumferentially arranged, and the locking bar 5 is arranged to be extendable and retractable to selectively fit into and engage with any one of the locking notches 27. In the instant embodiment, a driving bar 6 is connected between the locking bars 5, so that a user may operate the driving bar 6 to simultaneously move the locking bars 5 out of the locking notches 27 in order to enable rotation of the table top 1 and the rotatable frames 4.

In the instant embodiment, the rotation hole 26 is structured to extend curvedly along a circumference of the respective one of the rotation axles 25. When the rotatable frames 4 are rotate, the driving pegs 41 are caused to perform a circular motion, so that the circumferential extension of the rotation holes 26 allows the driving pegs 41 to move with the rotation of the rotatable frames 4 without being interfered with. Each of the lifting caster frames 22 is provided, on a top thereof, with a connection member 28 that receives the respective one of the driving pegs 41 to fit therein and connect therewith, so that when the rotatable frames 4 are rotated, the movements of the driving pegs 41 drive the lifting caster frames 22 to move. When the driving pegs 41 are moved downward with the rotation of the table top 1, the lifting caster frames 22 are pushed downward to protrude out of undersides of the table legs 2, respectively, (this being a state for moving); when the driving pegs 41 are moved upwards with the rotation of the table top 1, the lifting caster frames 22 are pulled upwards to respectively retract back into the interiors of the table legs 2 (this being a state of use). Each of the connection members 28 is formed with an elongated circular hole 29 extending in a horizontal direction and fit over and connected to the respective one of the driving pegs 41, in order to allow the circular motions of the driving pegs 41 to be smoothly converted into vertical movements of the lifting caster frames 22.

On an outer side of the top of each of the table legs 2, a decoration panel (not shown) may be provided to cover the rotation hole 26, the driving peg 41, and the connection member 28, in order to prevent the driving peg 41, when put in rotation, from colliding a foreign object. For simplifying the illustration, the decoration panel (not shown) is omitted from each of the drawings.

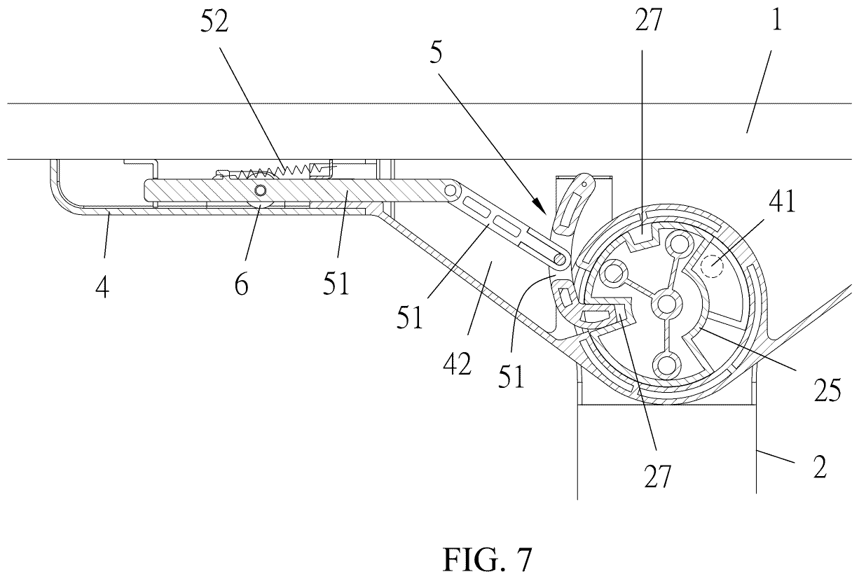

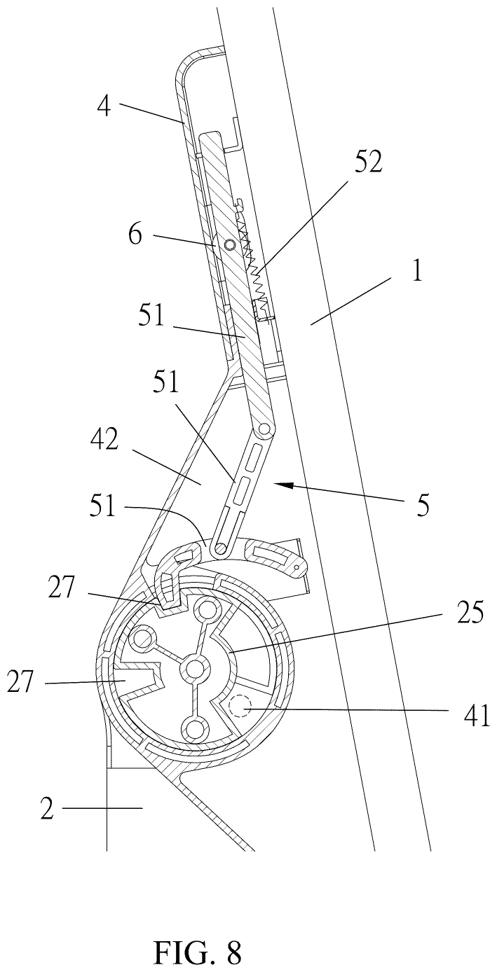

FIGS. 7 and 8 show that each of the locking bars 5 is connected to a return spring 52 in order to have the locking bar 5 pre-set in engagement with a specific one of the locking notches 27. When the locking bars 5 are released by a user and rotated to a designated position, the locking bars 5 are biased and pushed by the return springs 52 to get into another one of the locking notches 27. In the instant embodiment, each of the locking bars 5 is made up of a plurality of links 51 sequentially pivoted to each other, such as three links 51 being sequentially pivoted to make the locking bar 5. Among the links 51, the one that is closest to the rotation axle 25 is made in a hook shape for reaching into and engaging with the locking notches 27, and among the links 51, the one that is furthest from the rotation axle 25 is connected to the return spring 52 and the driving bar 6. When a user pulls the driving bar 6 in a direction away from the rotation axle 25, the links 51 are moved, in sequence, to get away from the rotation axle 25 so as to have the one of the links 51 that is closest to the rotation axle 25 disengaging and released from the locking notches 27, allowing the user to rotate and turn the table top 1; and when the table top 1 is rotated to the position shown in FIG. 8, the return spring 52 biases and pulls the links 51 to move toward the rotation axle 25, so that the one of the links 51 that is closest to the rotation axle 25 is pushed into and engages with another one of the locking notches 27. The driving peg 41 and the locking bar 5 are respectively arranged on two opposite sides of the rotation axle 25, for example the driving peg 41 being arranged at a lower side of the rotatable frame 4 when the table top 1 is in a rotated condition, and the locking bar 5 being arranged at an upper side of the rotatable frame 4 when the table top 1 is in the rotated condition.

The advantage of the present invention is that when the table top 1 is set horizontal and in a state of use, the casters 23 are retracted, so that positional change caused by rotation (not rolling) of the casters 23 may not happen, and the adjustable support rods 21 can be adjusted for the height thereof contacting the ground surface in order to handle unevenness of the ground surface, so that even the ground surface is irregular or uneven, the present invention does not shake; and when the present invention is to be moved, through rotation of the table top 1, the casters 23 are pushed downward to a position of protruding out of the table legs 2, so that the casters 23 are set in contact with the ground surface for easy movement, featuring both stability of use and easiness of stowage.

I claim:

1. A structure of foldable table, comprising a table top, two table legs, a cross bar connected between the table legs, and two rotatable frames, wherein two opposite side portions of an undersurface of the table top are each connected to a rotatable frame, and the rotatable frames are respectively mounted to top ends of the table legs, each of the table legs being provided, on a bottom thereof, with a plurality of adjustable support rods, wherein each of the table legs is provided with a lifting caster frame arranged in an interior thereof, and each of the lifting caster frames is provided, on a bottom thereof, with a plurality of casters, the lifting caster frames being respectively connected to the rotatable frames, so that when the table top is rotated together with the rotatable frames from a horizontal direction to a vertical direction, the lifting caster frames are caused to move downwards to have the casters protruding out of the table legs.

2. The structure of foldable table according to claim 1, wherein each of the table legs is formed, in an interior thereof, with a table leg receiving space to receive a respective one of the lifting caster frames therein, and each of the table legs is provided, on the top end thereof, with a rotation axle that protrudes inwards, the rotatable frames being respectively sleeved outside peripheries of the rotation axles, the cross bar being connected between the rotation axle, the table legs being each formed, in the top end thereof, with a rotation hole at one side of the rotation axle, each of the rotatable frames comprising a driving peg projecting toward the rotation hole, the driving pegs respectively extending through the rotation holes to reach into the table leg receiving spaces, the driving peg being respectively connected to the lifting caster frames, the rotatable frames being each formed, in an interior thereof, with a lock accommodation space in which a locking bar is received, each of the rotation axles being provided with a plurality of locking notches that are arranged circumferentially therearound, the locking bar being arranged to be extendable and retractable to selectively fit into and engage with one of the locking notches.

3. The structure of foldable table according to claim 2, wherein a driving bar is connected between the locking bars, and each of the locking bars is connected to a return spring so that the locking bar is pre-set in engagement with a predetermined one of the locking notches, the driving peg and the locking bar being respectively arranged on two opposite sides of the rotation axle, the adjustable support rods being mounted, by means of screwing, to the bottom of each of the table legs.
